(19) United States
(12) Patent Application Publication
(10) Pub. No.: US 2005/0042032 A1
(43) Pub. Date: Feb. 24, 2005

(54) Method of constructing a multi-layered athletic field

(75) Inventors: Joseph E. Motz, Cincinnati, OH (US); Mark A. Heinlein, Cincinnati, OH (US); Stephen L. Linville, Rydal, GA (US)

Correspondence Address: WOOD, HERRON & EVANS, LLP, 2700 CAREW TOWER, 441 VINE STREET, CINCINNATI, OH, 45202, US

(73) Assignee: Coevin Technologies, LLC, Chatsworth, GA (US)

(21) Appl. No.: 10/958,133

(22) Filed: Oct. 4, 2004

Related U.S. Application Data
(63) Continuation of application No. 10/634,217, filed on Aug. 5, 2003, now Pat. No. 6,800,339.
Application No. 10/634,217 is a continuation of application No. 10/028,221, filed on Dec. 21, 2001, now abandoned.

(51) Int. Cl. A41G 1/00; A01N 3/00; E03F 1/00

(52) U.S. Cl. 405/43; 428/17; 405/229; 405/36

(57) ABSTRACT

A method of constructing a multi-layered athletic field includes installing surface and subsurface layers over a foundation. The subsurface layer comprises a backing with a plurality of pile filaments secured thereto and extending upwardly to a desired level. A subsurface particulate fill material resides on the subsurface backing, to surround and support the subsurface pile filaments at the desired level, so that the filaments and the particulate are about the same height. This height, and the composition of the subsurface particulate fill material, are selected to achieve a desired degree of shock absorption for the athletic field. The subsurface particles may be retained, as by a hardened liquid binder sprayed thereon. Thereafter, the surface layer is installed on top of the subsurface layer. The surface layer forms the athletic playing surface, and has selectable playing characteristics determined by the corresponding structural features of the subsurface layer, particularly with respect to the composition and height of the subsurface particulate.

### CROSS REFERENCE TO RELATED APPLICATIONS

This application is a continuation of U.S. patent application Ser. No. 10/634,217, filed Aug. 5, 2003, and entitled “A Filled Synthetic Turf With Ballast Layer,” which is a continuation of U.S. patent application Ser. No. 10/028,221 filed Dec. 21, 2001, and entitled “A Filled Synthetic Turf With Ballast Layer,” which is now abandoned.

### FIELD OF THE INVENTION

This invention relates to synthetic turfs for athletic fields and, more particularly, to a synthetic turf filled with particulate material so as to give the field stability and resiliency.

### BACKGROUND OF THE INVENTION

A natural grass turf covering has traditionally been cultivated on playing surfaces for athletic games or events. In addition to looking good, natural grass turf provides inherent resiliency and cushioning, thereby minimizing the risk of injury due to an athlete's impact with the turf. Such natural grass turf coverings have traditionally been used to cover American football or soccer fields. Many athletes participating in these high impact sports desire a surface with a high degree of resiliency such as is provided by a natural grass turf covering.

However, maintenance of natural grass turf on athletic playing areas can be expensive and time consuming. Natural grass does not grow well within shaded areas like those within indoor or partially enclosed stadiums. In addition, some heavy traffic-locations on the playing field are susceptible to wearing out or deteriorating due to continuous or excessive wear. These worn areas may become muddy and slippery after the natural grass dies, increasing the likelihood of injury.

Therefore, various types of synthetic turf have been developed and installed on athletic playing surfaces, particularly surfaces located within indoor stadiums. Generally, these various synthetic turf surfaces reduce the expense of maintaining athletic playing surfaces and increase the durability of the turf surface. Synthetic turf generally comprises a flexible backing and a plurality of grass-like pile filaments or fibers extending upwardly from the backing. The flexible backing is typically laid on a foundation or compacted substrate, such as crushed stone or stabilized base material. Most earlier forms of synthetic turf relied solely on the backing and the pile filaments or fibers as the playing surface. ASTROTURF synthetic turf is an example of this type of artificial turf. However, in recent years there has been a move toward synthetic turfs which look and feel more like natural grass.

To do this, the pile filaments are generally increased in length, to more closely resemble the look of natural grass. Also, in order to give the synthetic turf a desired degree of resiliency and stability, a granular fill material is placed between or among the upstanding pile filaments of the synthetic turf. This granular fill material typically extends upwardly from the upper surface of the backing to a height below the tops of the pile filaments, thereby leaving upper portions of the pile filaments exposed for aesthetic purposes, among others. The granular fill material helps maintain in a substantially upright condition the filaments of the synthetic turf.

In the past this granular fill material has been sand, crushed slag particles, resilient foam, crumb rubber particles, sand or several different combinations of two or more of these materials. The most typical of these infill materials for synthetic turfs has been sand, because it is readily available at a relatively low cost, and it provides enough weight to hold the backing down during and after installation. This hold down aspect remains important even after installation, because filled synthetic turfs are subject to large temperature fluctuations, which results in contraction and expansion of the turf backing. A fill with at least one layer of sand stabilizes the backing of the synthetic turf and provides weight to minimize lateral movement of the backing.

U.S. Pat. No. 3,995,079 discloses a filled synthetic turf for golf greens, the granular fill material being granulated coal slag, crushed flint or crushed granite. The problem with the use of these particles as a fill material is that they are very abrasive. This inherent abrasiveness increases the probability of scrapes or abrasions to persons falling upon the filled synthetic turf.

U.S. Pat. No. 4,044,179 discloses a filled synthetic turf for athletic playing surfaces, wherein the granular fill material is sand with a small amount of moisture retaining material. The problem with the use of sand as the fill is that sand compacts over time and use, resulting in a filled synthetic turf which is harder than desired. Because such playing surfaces are commonly used for high impact sports, the harder the field, the greater the likelihood of injury for the players using the field. Another problem with using sand as the fill material is that sand retains water or moisture, thereby increasing the susceptibility of the filled synthetic turf to mold or mildew.

U.S. Pat. No. 4,337,283 discloses a filled synthetic turf for athletic playing surfaces, the granular fill material being a uniformly mixed combination of sand particles and resilient particles. One inherent problem with the use of such a mixture is that, over time and after repeated use, the resilient particles of the mixture tend to migrate to the top of the fill layer, with the sand tending to settle below the resilient particles. The sand that settles to the bottom of the fill layer tends to compact over time and use. This ultimately results in a layered synthetic turf which is harder and more abrasive than desired.

A further disadvantage of an initially uniform mixture of this type is that the top surface never remains completely mixed. Inevitably the top surface will have some localized regions of abrasive sand particles. This means that the playing surface is not uniform in performance characteristics across its entire surface area. It also means that for some regions of the field, players will inevitably come into contact with the sand particles and may suffer skin abrasions.

U.S. Pat. No. 5,958,527 discloses a filled synthetic turf with an infill of sand and resilient particles which are specifically layered, in an effort to overcome the above-described problems of a uniformly mixed sand/rubber infill. More particularly, the granular fill material comprises three separate layers of particles, with sand at the bottom, resilient particles at the top and a mixture therebetween. While this may be an improvement over prior uniformly mixed infills, the improvement tends to be short-lived. Over time and after repeated use, the sand at the bottom of the mixture tends to compact, causing the field to harden and to inhibit the vertical drainage of water off the field through the backing of the filled synthetic turf.

Also, as a synthetic field is used over time, the cleats of athletes tend to chum up and mix the various fill materials. Thus, even if a layered infill is used, eventually this cleat churning will result in some abrasive sand particles finding their way to the surface of the synthetic turf between the pile filaments. This results in upper areas of exposed sand, which means the playing surface lacks uniformity. Also, whenever an athlete falls or contacts the turf, the athlete is susceptible to cuts or abrasions due to the sand. Moreover, the sand particles located at the surface of the fill material also are abrasive to the pile filaments of the synthetic turf, thereby degrading and/or fibrillating the tops of the pile filaments over time. In short, based on applicants' present understanding of filled artificial fields, for infills with a mixture of sand and resilient particles, whether uniformly mixed or layered, the resilient effect of the rubber particles is only temporary. Therefore, it is an object of the present invention to sufficiently hold down the backing of a filled synthetic turf while eliminating the adverse effects presently associated with the use of sand.

It is another object of the present invention to extend the life of the resilient characteristics of a filled synthetic turf while still maintaining a high degree of directional stability for the synthetic backing.

It is still another object of the present invention to attain a longer lasting, uniformly resilient athletic playing surface at a relatively low cost, preferably with the playing surface being sufficiently versatile in design to accommodate a number of potential structural enhancements.

### SUMMARY OF THE INVENTION

According to one aspect of the invention, the present invention achieves these objects with a an athletic turf which is multi-layered, with a subsurface layer of filled turf which provides a selected and uniform degree of resiliency for the athletic playing surface, or layer, residing thereabove. For instance, a surface layer of filled synthetic turf resides above a subsurface lower layer of another filled synthetic turf. The subsurface filled synthetic turf comprises a subsurface backing with a plurality of subsurface pile filaments extending upwardly therefrom, to a desired height. A subsurface fill material resides on the subsurface backing, to a desired vertical height, and at a desired vertical relationship with respect to the height of the subsurface pile filaments. Generally, these vertical heights will be about the same. The subsurface fill material includes at least some resilient particles. The subsurface fill material may comprise two sublayers, with gravel or sand as a lower sublayer and resilient particles such as rubber particles as an upper sublayer. The subsurface fill material may be held in place with a binder, such as a sprayed on polymeric coating, applied to the subsurface fill material and the subsurface pile filaments. Other binders such as latex or urethane may be used to hold the subsurface fill material in place.

According to the present invention, the composition, and fill depths of the subsurface fill material, the height of the subsurface pile filaments, and/or the binder are selected to achieve, for the entire athletic playing field, a desired degree of shock absorption capability. Moreover, this multi-layered construction provides a uniformity in shock absorption capability, at a relatively low cost.

According to another aspect of the present invention, tubing may reside in the subsurface fill material above the subsurface backing, but below the tops of the subsurface pile filaments. The tubing operatively connects to a pump or other device to convey fluid within the tubing, to selectively heat or cool the subsurface and thereby heat or cool the filled synthetic turf located above the subsurface.

In yet another aspect of the invention, an athletic field comprises a filled synthetic turf which uses two layers of particulate fill. These two layers include a lower layer of a heavy and relatively large particulate, such as gravel, to serve as a ballast to hold down the backing, and an upper layer of resilient particles, such as rubber, residing over the ballast layer. The filled synthetic turf comprises a backing, a plurality of grass-like pile filaments secured to the backing and extending generally upwardly therefrom, and the dual layer particulate fill material residing on the backing. The backing is preferably a flexible, water permeable material. It may be a single layer of material or multiple layers of material joined together. The backing may reside over a subsurface layer, or on a foundation, such as crushed stone, dirt, asphalt, concrete, a pad or any other supporting surface. For drainage purposes, one or more drainage members may comprise part of the foundation.

The plurality of grass-like pile filaments preferably comprise synthetic ribbons of a selected length. They may be made of nylon, polyethylene or a polyethylene/polypropylene blend or any other material. They may be tufted, adhesively or otherwise joined to the backing. The pile filaments are preferably dyed or colored green so as to resemble the appearance of natural grass.

The fill material resides upon the backing and extends upwardly to a desired height which is below the tops of the pile filaments. This gives the field a green appearance, resembling natural grass. In addition, the particulate fill helps to prevent the pile filaments from moving or becoming trampled down.

As for the dual layer particulate fill material, the first lower layer comprises large heavy particles such as gravel to weigh down and hold the backing in place. According to the United States Golf Association (U.S.G.A.), gravel is defined as particles having a diameter greater than 2 millimeters and sand is defined as particles having a diameter less than 2 millimeters. Fine gravel is defined by the U.S.G.A. as particles having a diameter between 2 and 3.4 millimeters. Although the U.S.G.A. uses diameter to measure particulate size, the particles of the present invention need not be symmetrical, i.e. have a diameter. They may be irregularly shaped. The ballast particles of the present invention are not intended to be limited to gravel. One type of ballast particle which is suitable for the present invention has the following analysis: 100 percent passing through a 0.5 inch (12 millimeter) sieve; not more than 10 percent passing through a number 10 (2 millimeter) sieve; and not more than 5 percent passing through a number 18 (1 millimeter) sieve.

The second upper layer provides resiliency for the synthetic turf. The resilient particles are preferably synthetic particles such as rubber particles, commonly referred to as crumb rubber.

Generally, the height of the first lower layer is about equal to the height of the second upper layer. However, these relative heights may vary. For instance, for different athletic fields, depending on the primary sport for which the field is designated, there may be a greater desire for more “ballast” effect from the first lower layer. Alternatively, some installations may require more shock absorption, so the second upper layer may be proportionally greater in vertical dimension.

The objects and features of the present invention will become more readily apparent from the following detailed description and the accompanying drawings.

### BRIEF DESCRIPTION OF THE DRAWINGS

FIG. 1 is a horizontally directed cross-sectional view of a filled synthetic turf constructed in accordance with a first preferred embodiment of the invention.

FIG. 1A is a view similar to FIG. 1, but showing the filled synthetic turf residing on a slightly different foundation.

FIG. 1B is a view similar to FIG. 1, but showing another embodiment of the filled synthetic turf of the present invention.

FIG. 2A is a horizontally directed cross-sectional view of a multi-layer athletic turf constructed in accordance with a second preferred embodiment of the invention, with a subsurface filled synthetic turf.

FIG. 2B is a view similar to FIG. 2A, showing a variation of the subsurface filled synthetic turf, and a variation of the foundation.

FIG. 2C is a view similar to FIGS. 2B, but showing a variation of the surface which forms the playing surface, and a variation of the foundation.

FIG. 2D is a view similar to FIGS. 2A, 2B and 2C, showing a variation of the invention shown in FIG. 2B, namely a subsurface heating component and a foundation which includes a drainage element.

FIG. 3A is a perspective view of another aspect of the invention, namely a fluid system for heating or cooling the athletic field.

FIG. 3B is a perspective view, similar to FIG. 3A, showing an alternative structure for heating the athletic field.

### DETAILED DESCRIPTION OF THE PREFERRED EMBODIMENTS OF THE INVENTION

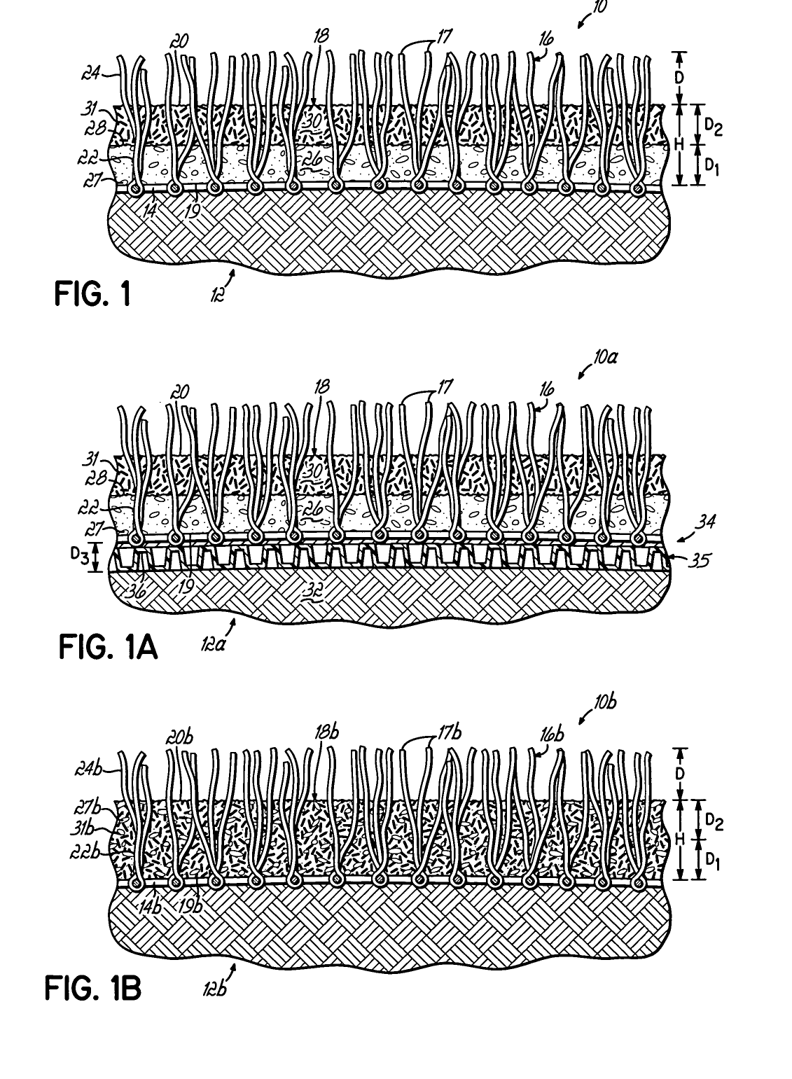

FIG. 1 illustrates a filled synthetic turf 10 incorporating the present invention. FIG. 1 illustrates the filled synthetic turf 10 resting upon a foundation 12. The foundation 12 may take any one of many known forms and may include crushed stone or the like known in the athletic playing field industry.

Referring to FIG. 1, the filled synthetic turf 10 of the present invention comprises a backing 14 residing on the foundation 12. The backing 14 is preferably made of a flexible, water permeable material but may be made of any type of material such as foam. Although FIG. 1 illustrates a single layer of backing 14, the backing 14 may comprise multiple layers joined together in any known manner.

A plurality of grass-like pile filaments 16 are secured to the backing 14 and extend generally upwardly therefrom terminating at ends 17. The pile filaments 16 comprise synthetic ribbons of a selected length and may be made of nylon, polyethylene, a polyethylene/polypropylene blend, or any other appropriate material. The pile filaments 16 may be tufted to the backing 14, glued to the backing 14, or secured to the backing in other known manner.

A particulate fill material 18 resides on the backing 14 and extends upwardly from the backing 14 to a desired height H. As illustrated in FIG. 1, the particulate fill material 18 has a lower surface 19 residing on the backing 14 and an upper surface 20 which is located a fixed distance D below the tops or ends 17 of the pile filaments 16. Thus, each of the pile filaments 16 has a lower portion 22 located inside the particulate fill material 18 and an upper portion 24 located above the particulate fill material 18. The upper portions 24 give the playing surface a green appearance or look resembling natural grass. The particulate fill material 18 helps stabilize the pile filaments 16 in place and helps prevent the pile filaments 16 from becoming trampled or run-down.

FIG. 1 shows the particulate fill material 18 is divided into at least two layers. Referring to FIG. 1, the particulate fill material 18 includes a first lower layer 26 of ballast particles 27 such as gravel located on the backing 14 and extending upwardly from the backing 14 a distance D, to an upper surface 28. A second upper layer 30 of resilient particles 31 rests on the upper surface 28 of the first lower layer 26. The first lower layer 26 provides weight and stability for the synthetic turf and helps hold the backing 14 in its desired location. The second upper layer 30 of resilient particles 31 such as rubber provides resiliency for the synthetic filled turf 10. The second upper layer 30 is of a height D₂ extending from the upper surface 28 of the lower layer 26 to the upper surface 20 of the particulate fill material 18.

FIG. 1A shows a filled synthetic turf 10a similar to that of FIG. 1. However, the foundation 12a is slightly different from that illustrated in FIG. 1. The foundation 12a illustrated in FIG. 1A comprises a solid lower portion 32 and an upper portion 34 comprising at least one drainage member 35 extending upwardly from the lower portion 32 a distance D₃. The drainage member 35 is illustrated as having a plurality of indentations 36 and an upper piece 38. One type of drainage member which has been successfully used is manufactured by the Nickelon Corporation of Norcross, Ga., and sold under the trademark MIRADRI.

FIG. 1B shows a filled synthetic turf 10b similar to that of FIG. 1. In this aspect of the present invention, the particulate fill material 18b is not divided into layers, but instead is a mixture of ballast particles such as gravel and resilient particles such as crumb rubber. The particulate fill material 18b extends upwardly from the backing 14b of the turf a height H to an upper surface 20b which is located below the tops 17b of the pile filaments 16b. The particulate fill material 18b includes a mixture of ballast particles 27b such as gravel and resilient particles 31b such as crumb rubber. Other particles may be included if desired.

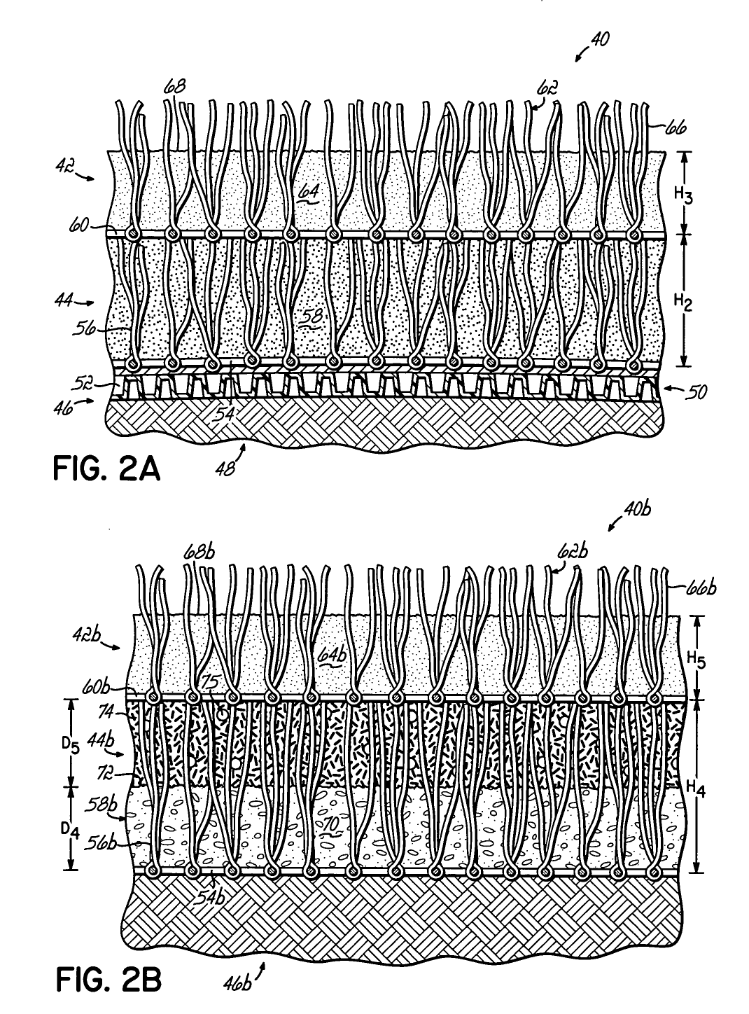

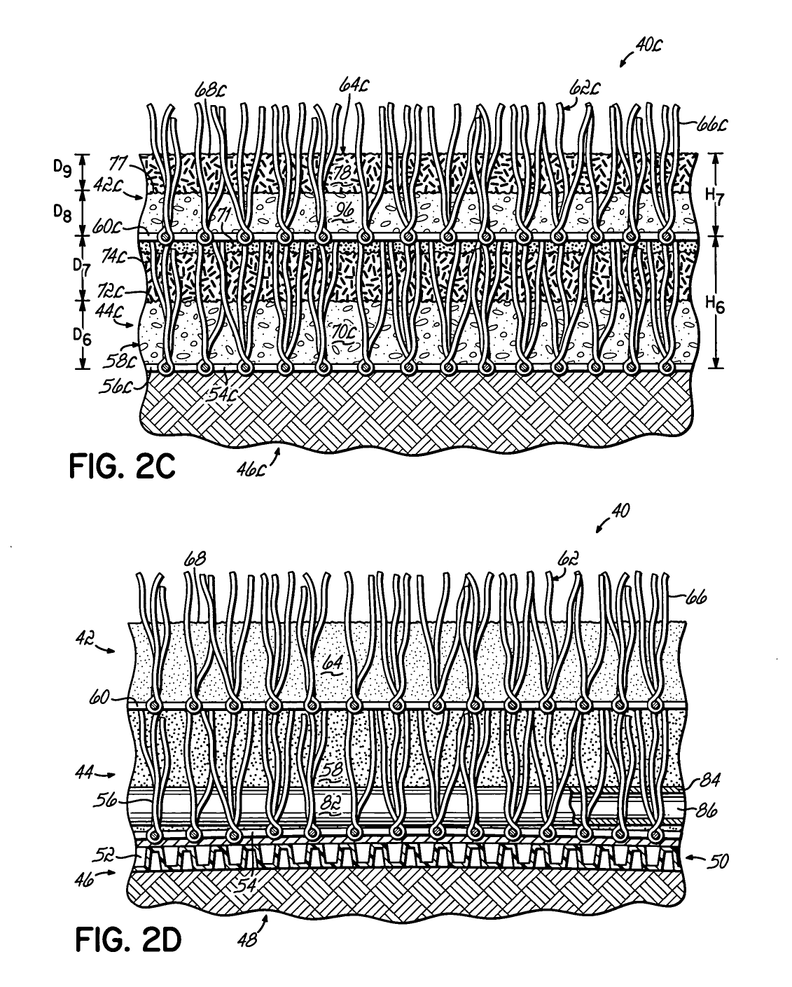

FIGS. 2A through 2D illustrate a multi-layered athletic playing surface, with a filled synthetic turf serving as the subsurface. FIG. 2A illustrates a filled synthetic turf 40 having an upper surface layer 42 of filled synthetic turf and a lower subsurface layer 44 resting on a foundation 46 and located below the upper surface layer 42 of filled synthetic turf. The foundation 46 comprises a lower portion 48 which is illustrated as being a solid member, but may be crushed stone or any other suitable foundation, and an upper portion 50 which may be one or more drainage members as described hereinabove and illustrated in FIG. 1A. Alternatively, the foundation 46 may be identical to the foundation 12 shown in FIG. 1.

Directly above the foundation 46 is the subsurface layer 44 comprising a subsurface backing 54 having a plurality of subsurface pile filaments 56 secured thereto and extending upwardly therefrom to a desired height H₂. The subsurface pile filaments 56 may be tufted or secured in any known manner to the subsurface backing 54. A subsurface fill material 58 resides on the subsurface backing 54 and extends upwardly a distance equal to the height H₂ of the subsurface pile filaments 56. However, the height of the subsurface fill material 58 may be any desired height. The subsurface particulate fill material 58 is illustrated as being a homogenous material. However, the subsurface particulate fill material 58 may be layered, a mixture or homogenous with any known or desired particulate fill material. FIG. 2A shows that the subsurface fill material 58 and the subsurface pile filaments 56 have a vertical dimension of about H₂.

Referring the FIG. 2A, the surface layer 42 comprises a filled synthetic turf having a surface backing 60 residing on the top of the subsurface layer 44. In addition, a plurality of surface pile filaments 62 are tufted or otherwise secured to the surface backing 60 in any known manner. A surface particulate fill 64 resides on the surface backing 60 to a desired vertical height H₃. In the embodiment illustrated in FIG. 2A, the surface particulate fill 64 is a homogenous material including at least some resilient particles such as crumb rubber. However, the surface particulate fill 64 may be any known particles. Each of the surface pile filaments 62 have an upper portion 66 extending above an upper surface 68 of the surface particulate fill 64.

In order to achieve a desired degree of shock absorption, the subsurface layer 44 and more particularly the subsurface pile filaments 56 may be of any desired height. The greater the desired degree of shock absorption, the greater the height of the subsurface layer 44. In addition, the composition of the subsurface particulate fill material may be modified to obtain the desired degree of shock absorption.

FIG. 2B shows a multi-layered athletic playing surface, but with a variation of the subsurface. For the sake of simplicity, this embodiment uses the same reference numbers for corresponding elements as the embodiment shown in FIG. 2A, but with a “b” designation after the appropriate numeral. More specifically, FIG. 2B shows a filled synthetic turf 40b comprising an upper surface layer 42b of filled synthetic turf and a lower subsurface layer 44b of filled synthetic turf resting on a foundation 46b.

Directly above the foundation 46b is the subsurface layer 44b comprising a subsurface backing 54b having a plurality of subsurface pile filaments 56b secured thereto and extending upwardly therefrom to a desired height H₄. The subsurface pile filaments 56b may be tufted or secured in any known manner to the subsurface backing 54b. A subsurface fill material 58b resides on the subsurface backing 54 and extends upwardly a distance equal to the height H₄ of the subsurface pile filaments 56b. The subsurface fill material 58b includes a first lower layer 70 of gravel located on the subsurface backing 54b and extending upwardly from the backing 54b a distance D₄ to an upper surface 72. A second upper layer 74 of resilient particles rests on the upper surface 72 of the first lower layer 70. The first lower layer 70 provides weight and stability for the subsurface layer and helps hold the subsurface backing 54b in its desired location. The second upper layer 74 of resilient particles such as rubber provides resiliency for the upper layer of synthetic filled turf. The second upper layer 74 is of a height D₅ extending from the upper surface 72 of the lower layer 70 to the tops of the subsurface pile filaments 56b.

In order to hold the subsurface fill material 58b in place, a binder 75 is located in the subsurface fill material. The binder 75 is illustrated in FIG. 2B as particles located throughout the second upper layer 74c of the subsurface fill material 58b. The binder 75 may be pellets of latex or a polyethylene which are activated by water, heat or any other known method. Alternatively, the binder 75 may be layered on top of the subsurface fill material as illustrated in FIG. 2C.

Referring the FIG. 2B, the surface layer 42b comprises a filled synthetic turf having a surface backing 60b residing on the top of the subsurface layer 44b. In addition, a plurality of surface pile filaments 62b are tufted or otherwise secured to the backing 60b in any known manner and extend upwardly therefrom to a desired height. A surface particulate fill 64b resides on the surface backing 60b to a desired vertical height H₅. The surface pile filaments 62b each have an upper portion 66b extending above an upper surface 68b of the surface particulate fill 64b. In the embodiment illustrated in FIG. 2B the surface particulate fill 64b is a homogenous material, including at least some resilient particles such as crumb rubber. However, the surface particulate fill 64b may be layered with any known or desired particles, preferably including at least some resilient particles for shock absorption.

In all of the embodiments of the multi-layered athletic surface of this invention, in order to achieve a desired degree of shock absorption, the subsurface layer 44b may be of any desired height and the subsurface particulate fill 58b may be of any desired material. FIG. 2B shows the height of the subsurface particulate fill 58b and the subsurface pile filaments 62b as being about the same.

FIG. 2C shows another variation of a multi-layered athletic field. For the sake of simplicity, this embodiment will utilize the same numbers for corresponding elements as the embodiments illustrated in FIGS. 2A and 2B but with a “c” designation after the appropriate numeral. More specifically, FIG. 2C illustrates a multi-layered filled synthetic turf 40c comprising a foundation 46c, a lower subsurface layer 44c of filled synthetic turf resting on the foundation 46c and an upper surface layer 42c of filled synthetic turf. The foundation 46c is illustrated as being a uniform member, but may have multiple layers which may include one or more drainage members as described and illustrated hereinabove.

Directly above the foundation 46c is the subsurface layer 44c of filled synthetic turf comprising a subsurface backing 54c having a plurality of subsurface pile filaments 56c secured thereto and extending upwardly therefrom to a desired height H₆. The subsurface pile filaments 56c may be tufted or secured in any known manner to the subsurface backing 54c. A subsurface fill material 58c resides on the subsurface backing 54c and preferably extends upwardly a distance equal to the height H₆ of the subsurface pile filaments 56c. The subsurface fill material 58c includes a first lower layer 70c of gravel located on the subsurface backing 54c and extending upwardly from the backing 54c a distance D₆ to an upper surface 72c of the first lower layer 70c. A second upper layer 74c of resilient particles rests on the upper surface 72c of the first lower layer 70c. The first lower layer 70c provides weight and stability for the subsurface layer and helps hold the subsurface backing 54c in its desired location. The second upper layer 74c of resilient particles such as rubber provides resiliency for the upper layer of synthetic filled turf. The second upper layer 74c is of a height D₇ extending from the upper surface 72c of the lower layer 70c to the tops of the subsurface pile filaments 56c.

In order to hold the subsurface fill material in place, a binder 71 is layered on top of the subsurface fill material. The binder 71 is illustrated in FIG. 2C as a polymeric coating layer located on top of the second upper layer 74c of the subsurface fill material. The polymeric coating layer may be a urethane sprayed or otherwise applied to the top of the subsurface fill material. However, the binder 71 may be applied using other known methods. Alternatively, the binder 75 may be located throughout the subsurface fill material as illustrated in FIG. 2B.

Referring the FIG. 2C, the surface layer 42c comprises a filled synthetic turf having a surface backing 60c residing on the top of the subsurface layer 44c. In addition, a plurality of surface pile filaments 62c are tufted or otherwise secured to the backing 60c in any known manner. A surface particulate fill 64c resides on the surface backing 60b to a desired vertical height H₇. The surface pile filaments 62c each have an upper portion 66c extending above an upper surface 68c of the surface particulate fill 64c.

The surface particulate fill 64c is illustrated in FIG. 2C as a having two layers, a lower layer 76 and an upper layer 78. However, the surface particulate fill 64c may comprise any number of layers of fill or be homogenous material as illustrated in FIG. 2B. The surface fill material 64c includes a first lower layer 76 of gravel located on the surface backing 60c and extending upwardly from the surface backing 60c a distance D₈ to an upper surface 77. A second upper layer 78 of resilient particles rests on the upper surface 77 of the first lower layer 76. The first lower layer 76 provides weight and stability for the subsurface layer and helps hold the surface backing 60c in its desired location. The second upper layer 78 of resilient particles such as rubber provides resiliency for the upper layer 42c of synthetic filled turf. The second upper layer 78 is of a height D₉ extending from the upper surface 77 of the lower layer 76 to an upper surface 68c spaced below the tops of the surface pile filaments 62c.

FIG. 2D illustrates the multi-layered filled synthetic turf illustrated in FIG. 2A . In addition, hollow tubing 82 extends through the subsurface layer 44. The tubing 82 comprises an exterior wall 84 having a hollow interior 86 such that fluid (not shown) may flow through the tubing 82. The tubing 82 resides within the subsurface fill material above the subsurface backing and below the tops of the subsurface pile filaments. The tubing 82 is adapted to be operatively connected to a pump to convey fluid through the tubing 82 to selectively heat or cool the subsurface, thereby heating or cooling the surface layer 42 of the multi-layered filled synthetic turf.

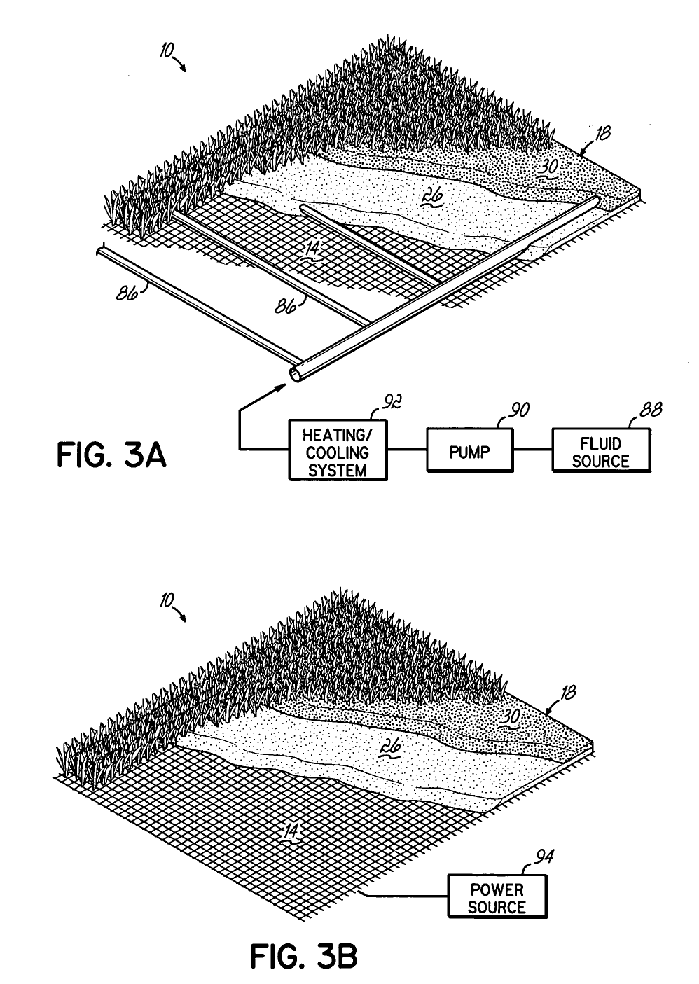

FIG. 3A shows a heating/cooling system for use of a fluid to heat or cool an athletic field, which may be a multi-layered athletic field as shown in FIG. 2D. But in this instance, in FIG. 3A, the athletic field shown is a filled synthetic turf having two layers of particulate fill material, similar to the field shown in FIG. 1. For the sake of simplicity, the numerals used to describe the embodiment illustrated in FIG. 1 are repeated. Multiple interconnected tubes 86 are operatively connected to a fluid source 88 which contains water or air, for example. A pump 90 or other suitable structure conveys or forces fluid (not shown) from the fluid source 88 into the tubes 86. A heating/cooling system 92 heats or cools the fluid to the appropriate temperature. Although the tubes 86 are shown in parallel rows, connected at their ends, they may assume any other desired configuration which adequately covers the field, such as a serpentine configuration.

FIG. 1 shows the tubes 86 residing within the first lower layer 26 of gravel within the particulate fill material 18. However, the tubes 86 may reside within the upper layer 30 of resilient particles or through both layers, if desired. Alternatively, if a homogenous particulate fill material is used rather than a layered particulate fill material, the tubes 86 may be located at any desired depth therein.

FIG. 3B shows a variation on this temperature control concept, for an athletic surface similar to that shown in FIG. 1. For the sake of simplicity, the numerals used to describe the embodiment illustrated in FIG. 1 are repeated. To heat the filled synthetic turf 10, the backing 14 is operatively connected to a power source 94 which supplies electrical energy to heat the backing 14 and the field 10. This method of heating the filled synthetic turf may be used with any type of synthetic turf having a backing, regarding of the particulate fill material.

In use, unfilled synthetic turf is unrolled in strips on a foundation where the athletic playing surface is to be located. The strips are preferably 8 feet in width but may be any desired width. Adjacent strips are sewn or joined together along the longitudinal edges in a conventional manner. As shown and described, the foundation may include a drainage member. The pile filaments extend upwardly from the backing. The particulate fill material is then placed on the backing to a desired vertical height. The pile filaments of the synthetic turf extend above the upper surface of the fill material. The particulate fill material is applied in layers. The first lower layer of gravel is first located on the backing in a quantity sufficient to extend upwardly from the backing to a desired height. The second upper layer of resilient particles is then located on top of the first lower layer of gravel in a quantity sufficient to extend upwardly from the first lower layer to a desired height.

If the subsurface layer is to be used, the above steps may also be used to form a surface layer, i.e. the athletic field, of a filled artificial turf. Alternatively, the surface layer may vary in construction, by varying the particulate fill depth, the particulate fill composition, or even the playing surface itself, such that an unfilled turf is used. Moreover, the unfilled turf may be synthetic turf, or even natural grass. Regardless, the underlying subsurface includes a subsurface backing located in rolls on a foundation, and then secured together. The subsurface backing has upwardly extending pile filaments which extend upwardly to a desired vertical height. Particulate fill material is then filled in to the desired vertical height, and preferably the particulate is then treated to hold the particulate in place. If the subsurface particulate is crumb rubber, for instance, the binder may be a sprayed on polymeric coating, which solidifies to hold the rubber in place. This creates a subsurface layer with a desired amount of shock absorption, and uniformity in shock absorption. Particularly for outdoor installations, the subsurface backing may reside on a drainage layer, to facilitate drainage and spacially separate the subsurface backing from draining water.

From the above disclosure of the general principles of the present invention and the preceding detailed description of at least one preferred embodiment, those skilled in the art will readily comprehend the various modifications to which this invention is susceptible. Therefore, we desire to be limited only by the scope of the following claims and equivalents thereof.

1. A method of constructing an athletic field on a foundation comprising:
a) installing a subsurface layer over the foundation, the subsurface layer including a subsurface backing with a plurality of subsurface pile filaments extending generally upwardly therefrom;
b) filling a subsurface particulate material on the subsurface backing to a desired vertical level, the subsurface particulate material surrounding and supporting the subsurface pile filaments and the subsurface particulate material including resilient particles;
c) retaining the subsurface particulate material on the subsurface backing at the desired vertical level, thereby to hold the subsurface particulate material in place relative to the subsurface backing; and
d) installing a surface layer over the subsurface layer, the surface layer serving as an athletic field, the composition of the subsurface particulate material being selected to achieve a desired degree of resilience and shock absorption capability for the athletic field.

2. The method of claim 1 wherein the subsurface pile filaments extend generally upwardly to about the desired vertical level, so that the subsurface pile filaments and the subsurface particulate have about the same vertical level.

3. The method of claim 1 wherein the retaining step comprises:
spraying a binder on the subsurface particulate material prior to the installing step.

4. The method of claim 1 further comprising the step of:
installing a drainage layer on the foundation prior to the step of installing the subsurface layer, so that the subsurface layer resides on the drainage layer.

5. The method of claim 4 wherein the foundation is asphalt.

6. The method of claim 1 wherein the installed surface layer comprises an artificial turf.

7. The method of claim 6 wherein the artificial turf is a filled artificial turf, and further comprising:
filling the surface layer with a particulate fill to a desired height.

8. The method of claim 7 wherein the filling of the surface layer further comprises:
filling a first lower layer of relatively large and heavy particles, to serve as a ballast layer;
filling a second layer of resilient particles on the ballast layer, the filled artificial turf including a plurality of grass-like pile filaments extending a desired distance above the second layer of resilient particles.

9. An athletic field made according to the method of claim 1.

10. The method of claim 1 further comprising:
locating a tubing circuit within the subsurface particulate material, the tubing circuit adapted to convey fluid therein to selectively heat or cool the subsurface layer and the athletic field thereabove.

11. A method of constructing a filled artificial turf playing surface on a foundation, comprising the steps of:
a) installing a subsurface layer over the foundation, the subsurface layer including a subsurface backing with a plurality of subsurface pile filaments extending generally upwardly therefrom to a desired vertical level;
b) filling a subsurface particulate material on the subsurface backing to the desired vertical level, the subsurface particulate material surrounding and supporting the subsurface pile filaments, the subsurface particulate material including resilient particles;
c) installing a surface layer on the subsurface layer, the surface layer including a backing and a plurality of surface pile filaments extending generally upwardly from the backing, the surface pile filaments having upper ends; and
d) filling a surface particulate on the surface backing to a desired height, the desired height residing below the upper ends of the surface pile filaments, the surface particulate surrounding and supporting the surface pile filaments, the surface layer forming the athletic playing surface of the athletic field, and whereby the subsurface layer provides a desired degree of shock absorption for the athletic field.

12. The method of claim 11 wherein the foundation comprises a lower layer of asphalt and an upper drainage layer, the subsurface layer residing on the drainage layer.

13. The method of claim 11 further comprising:
retaining the subsurface particulate fill at the desired vertical level.

14. The method of claim 13 wherein the retaining further comprises:
applying a binder prior to installing the surface layer.

15. The method of claim 14 wherein the applying further comprises:
spraying on a polymeric coating.

16. A filled artificial turf made according to the method of claim 11.

17. An athletic surface comprising:
a foundation;
a subsurface layer supported by the foundation and a surface layer comprising a filled synthetic turf supported by the subsurface layer, the subsurface layer comprising
a subsurface flexible backing with a plurality of grass-like subsurface pile filaments extending generally upwardly therefrom to a desired height;
a subsurface fill material residing on the subsurface backing, the subsurface fill material also extending to the desired height, and the subsurface fill material including at least some rubber particles, wherein the composition of the subsurface fill material and the desired height are selected to achieve a desired degree of shock absorption for the surface layer supported thereon.

18. The athletic surface of claim 17, further comprising:
a drainage member residing on the foundation.
